(19) United States
(12) Patent Application Publication
(10) Pub. No.: US 2014/0298940 A1
(43) Pub. Date: Oct. 9, 2014

(54) METHOD OF MANUFACTURING MULTI-MATERIAL GEARS

(71) Applicant: Imperial Innovations Limited, London (GB)

(72) Inventors: Jianguo Lin, London (GB); Denis Politis, London (GB); Trevor Anthony Dean, West Midlands (GB); Daniel Balint, London (GB)

(73) Assignee: Imperial Innovations Limited, London (GB)

(21) Appl. No.: 14/351,990

(22) PCT Filed: Oct. 25, 2012
(86) PCT No.: PCT/GB2012/052661

§ 371 Date: Apr. 15, 2014

(30) Foreign Application Priority Data
Oct. 25, 2011 (GB) 1118466.0

(51) Int. Cl. B21K 1/30; F16H 55/06

(52) U.S. Cl. CPC B21K 1/30; F16H 55/06
USPC 74/434; 29/893.34

(57) ABSTRACT

A method of manufacturing a multi-material gear is disclosed. The method comprises the steps of (a) heating a first pre-form element of a first material to a temperature at which the first material can be formed; (b) heating a second pre-form element of a second material to a temperature at which the second material can be formed; and (c) forming the first and second pre-form elements in a die at least towards the shape of the gear, thereby providing bonding between the elements.

### FIELD

This invention relates to a method of manufacturing multi-material gears.

### BACKGROUND

Gears are used in a wide range of applications, including but not limited to automotive, aerospace, marine, agricultural, conveyor systems, power stations, mining industry, solar energy systems and wind turbines. The gear industry has been a rapidly growing industry in recent years due to increased demand from developing nations. It is estimated that demand for gears will continue to increase in coming years. The greatest increase in demand is expected to be in automobile applications for developing countries and also from an increasing demand in wind and solar energy units.

Gears are made from various materials ranging from wrought metal alloys including steel and nickel super-alloys (such as 16 MnCr5, AISI 4320 and AISI 9310), to powdered metals, to plastics such as nylon.

There are regions of a gear where the material experiences more severe service conditions than do others. Higher stresses are experienced in areas such as the contact line between two meshing gears, the root of the tooth, and possibly at the keyway or splines which can attach the gear to the shaft on which it is mounted. These regions experience larger stresses than the remaining material located in the core of the gear. High stresses, such as teeth contact stresses, diminish very quickly with depth normal to the tooth contact point, for example, there can be a 50% reduction in stress only 0.5 mm into the depth of the gear tooth.

Therefore, as high stresses are located at certain areas of a gear, and diminish rapidly with increasing depth, it is proposed to produce a multi-material gear, whereby high performance materials are used in stress critical areas of the gear, and lower performance materials (lighter or less expensive materials) are used for less critical regions. The use of multiple materials allows a gear to be optimized for various purposes, such as, lightweight, low cost, corrosion resistance, high performance etc. For example, a lightweight gear can be produced by using a low density material in the core, or intermediate region, with conventional material being used for the critical regions, periphery and core. A low cost gear can be produced by using a low cost material in the core, and using high performance materials only for the critical regions to be capable of transmitting the required loads.

Multi-material gears have been proposed in the past. For example, a (U.S. Pat. No. 5,271,287) by Albert Wadleigh has proposed a multi-metal gear, by friction welding an inner aluminium core metal to a ‘steel outer annular gear toothed profile’. Furthermore, a bi-metal casting technique for producing gear blanks is already in use by Miller Centrifugal Casting Company. Furthermore, bi-metal gears have been produced by machining to shape an inner lightweight core and steel exterior and combining the two through threads. Lightweight gears have been produced also by machining holes in the inner region of a solid gear, but this is expensive.

### SUMMARY

The proposed method for producing a multi-material gear is through a forming process that may comprise forging. During this process, various bonding techniques such as mechanical as well as diffusion bonding may be used to obtain structural integrity at the interfaces between the different materials to create a gear which has the overall mechanical performance of a conventional gear.

According to an aspect of this invention, there is provided a method of manufacturing a multi-material gear comprising the steps of:

(a) heating a first pre-form element of a first material to a temperature at which the first material can be formed;

(b) heating a second pre-form element of a second material to a temperature at which the second material can be formed; and

(c) forming the first and second pre-form elements in a die at least towards the shape of the gear, thereby providing bonding between the elements.

Various processes exist for manufacturing gears; these processes can be grouped as either cutting or forming processes. For the forming processes, plastic gears are typically manufactured by injection moulding, whereas metallic gears can be produced from castings or forgings. Forging is preferred over casting as it produces gears at higher production rates, improved surface finish, lower raw material consumption and allow cost savings. Forged gears also exhibit superior mechanical properties to cast ones as they can have a fine grained microstructure without pores. Forged gears also exhibit higher strength, particularly dynamic strength, than machined gears because material fibres are aligned in a favourable orientation to increase strength instead of being truncated.

One or both heating steps may take place in a furnace or a respective furnace. One or both heating steps may be preceded by the step of placing each pre-form element in the or a respective furnace. The or each furnace may be heated so as to heat the pre-form elements or the respective pre-form element to the temperature at which they or it can be formed.

The temperature at which the first material can be formed may be substantially the same as the temperature at which the second material can be formed. In this case, the pre-form elements may be hearted in the same furnace. The temperature at which the first material can be formed may be substantially different from the temperature at which the second material can be formed. In this case, the pre-form elements may be heated in separate furnaces.

The pre-form elements may be arranged to be juxtaposed. They may be arranged to fit one inside the other. They may be substantially cylindrical, and may be annular. They may be arranged to fit axially one inside the other. An outer one of the elements may be shaped partly towards the shape of the radially outer part of the gear to be manufactured. This may comprise the outer one of the elements having projections that correspond to teeth of the gear. The outer and/or the inner element may have substantially cylindrical outer and/or inner surfaces.

The method may comprise the step of juxtaposing the pre-form elements; this may comprise the step of placing them one inside the other. The method may comprise juxtaposing the elements after heating, for example where the forming temperatures are different; it may comprise juxtaposing the elements before heating, for example where the forming temperatures are substantially the same. The method may comprise juxtaposing the elements in the die before forming. The method may comprise moving the elements from the or each furnace to the die.

The forming may comprise applying a force to the elements to deform at least part of each element. The deformation may be such as to provide mechanical bonding, for example by mechanical keying, between the elements. The deformation may be such as to provide diffusion bonding between the elements. The deformation may be such as to provide adhesion between the elements. The bonding and/or adhesion may be to resist relative angular movement of the elements. The force may be a substantially axial force to cause substantially radial deformation. The method may comprise deforming the elements by different radial amounts at different angular positions. The method may comprise deforming the elements more at angular positions that correspond to the angular positions of gear teeth of the gear. The forming may comprise forming the elements together in the die towards the shape of the gear.

There may be more than two pre-form elements. A third pre-form element may be provided. It may be of a third material, or of the first or second material. Depending on its material, and hence the temperature at which is can be formed, it may be heated in the same furnace as the first and/or second element, or heated in a separate furnace or may not be heated. The third element may also be arranged for juxtaposition with the first or second element by, for example, fitting inside one of those elements. The third element may also be substantially cylindrical and may be substantially annular. The third element may be deformed in the same way as the first and/or second element. There may be further pre-form elements, each heated and then formed together with the other elements in a similar way.

One of the materials may be a higher performance material; one of the materials may be a lower performance material. The material of the outermost element may be a higher performance material. The material of the innermost element may be a higher performance material; it may be a lower performance material. The material of an element between the outermost element and the innermost element may be a lower performance material. Performance may be performance in terms of strength and/or hardness and/or weight.

The first and second material may be metal; they may be plastic. One or each of the materials may be, for example, steel alloy, nickel super-alloy, aluminium alloy, magnesium alloy.

According to another aspect of this invention, there is provided a gear as defined hereinabove.

### BRIEF DESCRIPTION OF THE DRAWINGS

FIG. 1 is a perspective view of a gear formed from three different materials;

FIG. 2 is a schematic diagram of a method of manufacturing the gear; and

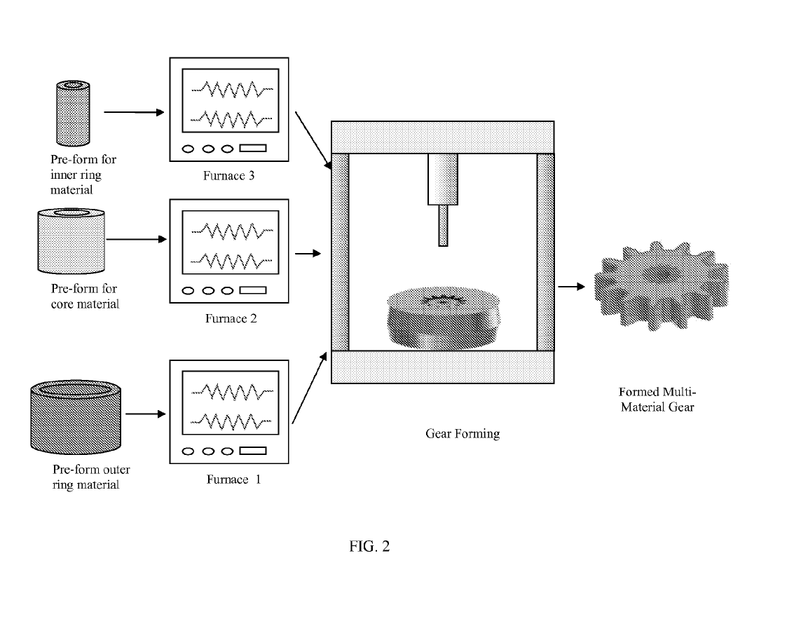

FIG. 3 shows two views of a gear made by a method according to an embodiment, the gear being formed of two materials.

### SPECIFIC DESCRIPTION OF CERTAIN EXAMPLE EMBODIMENTS

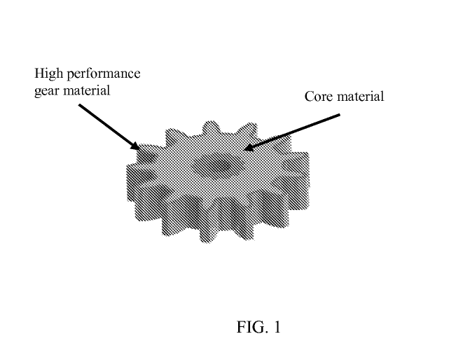

An example of a multi-material gear manufactured in accordance with a method that amounts to an embodiment is shown in FIG. 1. As can be seen from the figure, the higher performance gear material is applied to the high stress regions, whereas lighter weight material is applied in low stress core regions.

The forging method to produce this gear depends on the materials chosen. For example, if two metals are chosen, which have similar melting temperatures, such as titanium (1725° C.) and steel (1500° C.) [12], then the heating may be carried out within one furnace. However, if dissimilar metals, such as magnesium (685° C.) and steel (1500° C.) are chosen, different heating facilities may be required to heat individual materials to their required forging temperatures.

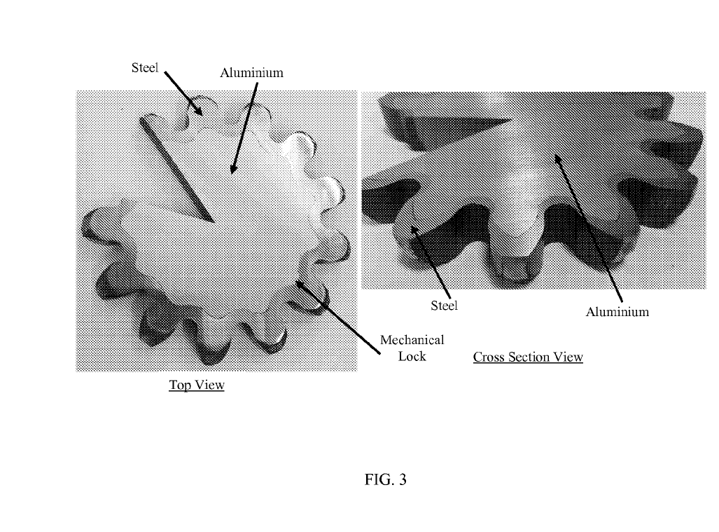

A description of the forming process is outlined below:
Prepare pre-forms for each of the materials to be used. For example, a 3-material gear requires pre-forms for an outer ring, inner core and inner ring. More layers can be added if necessary.
Heat the individual pre-forms to their required forming temperatures in furnaces. For example, the furnace for steel is heated to about 1100° C., whereas the furnace for aluminium or magnesium could be approximately 500° C.
Place the pre-forms sequentially onto the die set.
Form the gear using a press or other type of forming machine. Lubricant can be applied to the materials or forging tool set as appropriate to reduce friction, or reduce surface degradation, or promote diffusion bonding.
Eject the forged gear from the die.
FIG. 3 shows cross sections of formed lightweight bi-metal gears with a steel outer ring and an aluminium inner core. As shown in FIG. 3, the gear exhibits a strong mechanical lock between the materials used due to the extensive deformation of all materials as they flow to form the gear teeth. Additional locking is obtained due to diffusion bonding between the two materials as has been observed.
If magnesium or magnesium core material is used, the material has low formability and an outer steel ring could provide compressive forces to prevent cracking of the lightweight material during the forming process.

It is envisaged that, in embodiments:
Gears can be made from various materials ranging from metals alloys including steel and nickel super-alloys, and plastics such as nylon.
All gears require materials which exhibit certain mechanical properties such as high strength, high stiffness and good wear resistance. However, these properties usually come at the expense of either being heavy or of high cost.
It is unnecessary to use the same high performance gear material throughout the entire gear. Certain regions of the gear, such as the contact line between two meshing gears, the root of the tooth, and possibly a keyway or splines attaching the gear to the shaft experience larger stresses than material located in the core of the gear.
A multi-material gear is proposed in which high performance gear materials are used in critical areas of the gear, and lower performance materials are used for less critical regions. The materials can be chosen depending on the particular application, whether it is to produce a low cost gear, or a lightweight gear etc.
These multi-material gears will be produced essentially through a forming/forging process. A forging process produces better overall mechanical properties compared to casting. In the document, use the word ‘forming’ instead of ‘forging’ process in order to widen the scope of possible deformation modes.
The different materials can be joined by one or more methods, such as ‘mechanical bonding’, ‘diffusion bonding’ and adhesion.

1. A method of manufacturing a multi-material gear comprising the steps of:
(a) heating a first pre-form element of a first material to a temperature at which the first material can be formed;
(b) heating a second pre-form element of a second material to a temperature at which the second material can be formed; and
(c) forming the first and second pre-form elements in a die at least towards the shape of the gear, thereby providing bonding between the elements.

2. A method according to claim 1, wherein one or both heating steps takes place in a furnace or a respective furnace.

3. A method according to claim 1, wherein the temperature at which the first material can be formed is substantially the same as the temperature at which the second material is formed.

4. A method according to claim 1 wherein the temperature at which the first material can be formed is substantially different from the temperature at which the second material can be formed.

5. A method according to claim 1 and comprising the step of juxtaposing the heated pre-form elements for example by placing them one inside the other.

6. A method according to claim 1 and comprising applying a force to the elements to deform at least part of each element.

7. A method according to claim 6, wherein the deformation is such as to provide mechanical bonding, for example by mechanical keying, between the elements; and/or the deformation is such as to provide diffusion bonding between the elements; and/or the deformation is such as to provide adhesion between the elements.

8. A method according to claim 7, wherein the bonding and/or adhesion is to resist relative angular movement of the elements.

9. A method according to claim 6, wherein the force is a substantially axial force to cause substantially radial deformation.

10. A method according to claim 1, comprising deforming the elements by different radial amounts at different angular positions.

11. A method according to claim 1, comprising deforming the elements more at angular positions that correspond to the angular positions of gear teeth of the gear.

12. A gear according to claim 1.
